(19) United States
(12) Patent Application Publication
(10) Pub. No.: US 2026/0162480 A1
(43) Pub. Date: Jun. 11, 2026

(54) SYSTEM AND METHOD FOR SECURITY AND ACCESS CONTROL FOR ELECTRONIC LOCKS

(71) Applicant: Kenstan Lock and Hardware Company, Inc., Plainview, NY (US)

(72) Inventors: Wayne Nemeth, Rye, NY (US); Edward Kuzemchak, New Kensington, PA (US); Kevin Fundarek, Brightwaters, NY (US)

(21) Appl. No.: 19/414,219

(22) Filed: Dec. 9, 2025

Related U.S. Application Data
(60) Provisional application No. 63/729,662, filed on Dec. 9, 2024.
(60) Provisional application No. 63/729,671, filed on Dec. 9, 2024.

(51) Int. Cl. G07C 9/00

(52) U.S. Cl. CPC G07C 9/00571; G07C 9/00309; G07C 2009/00412; G07C 2209/63

(57) ABSTRACT

A system and method for security and access control of electronic locks are disclosed. The system enables secure access using a mobile device, RFID/NFC tags, or physical keys. The method leverages a proximity sensor to activate the lock from a low-power state when a user device approaches. Authentication is performed locally on the lock through multiple embodiments, including: (1) a handshake involving NFC signature verification and encrypted Bluetooth Low Energy (BLE) communication followed by a Time-Based One-Time Password (TOTP); or (2) a cryptographic access token mechanism utilizing asymmetric cryptography. In the token-based embodiment, the lock verifies a digital signature using a stored public key and compares a hierarchical lookup identifier in the token against a locally stored device identifier. The lock operates independently of real-time cloud connectivity while supporting centralized updates via a long-range wireless gateway.

### CROSS-REFERENCE TO RELATED APPLICATIONS

The present application claims the benefit of and priority to U.S. Provisional Patent Application No. 63/729,662 filed on Dec. 9, 2024 and U.S. Provisional Patent Application No. 63/729,671 filed on Dec. 9, 2024. The entire contents of the foregoing applications are incorporated in their entirety by reference herein.

### BACKGROUND

Electronic locks have been frequently used for home and building access doors. However, there is a need for a new generation of full-featured compact electronic locks that provide security, access control and usage data for fixtures, such as cabinets, cases, drawers, storage, lockers, etc. This new generation of wireless lock is battery powered or wired to power and has intelligence built into the lock such that it's able to make access control decisions in coordination with an organization's global access control standards and security requirements.

Electronic locks provide organizations such as retailers, hospitals, schools, governmental agencies and gyms better digital security, near real-time changes to access control, historical tracking, centralized control, threat alerts, and ultimately operational savings.

Key management is one of the biggest challenges to organizational security, especially when managing many locks with many users whose access privileges may be frequently changing, as is the case in retail stores. Security breaches in physical locks and keys typically involve replacing or rekeying lock cores and reissuing keys with the new key pattern. Solutions attempting to use battery powered electronic smart keys to provide security and tracking, and in some designs power to the lock from the key, all increase operational complexity and cost. Thus, there is a need for a smart lock with digital wireless access and independent power and intelligence, which can simplify the operational challenges and cost of managing multiple physical keys, while still offering the option of a physical key as secondary means of access.

### SUMMARY

Companies and organizations have diverse needs that require flexible access strategies. The present disclosure provides for a lock design that incorporates multiple digital forms of access and an optional physical key, any of which may be emphasized or disabled while still maintaining a fully functional lock. The following methods can be used to securely access the lock:
1. Mobile device/phone application or mobile computer using NFC and/or Bluetooth;
2. Radiofrequency identification/near field communication (RFID/NFC) tag, card or fob;
3. Wireless or wired controller may be used to grant access to authorized customers/users or enable access from a centralized or cloud-based access control software; and
4. Optional physical lock and key, such as a K2.

### BRIEF DESCRIPTION OF DRAWINGS

Various embodiments of the present disclosure are described herein below with reference to the figures wherein:

FIG. 1 is a schematic diagram of a lock management system according to an embodiment of the present disclosure;

FIG. 2 is a schematic diagram of a lock according to an embodiment of the present disclosure;

FIG. 3 shows top, side, and front view of the lock of FIG. 2;

FIG. 4 is a schematic diagram of an authentication process according to an embodiment of the present disclosure;

FIG. 5 is a flow chart of a method of using a mobile device as a key according to an embodiment of the present disclosure; and

FIG. 6 is a flow chart of a method of cryptographic token-based access control according to an embodiment of the present disclosure.

### DETAILED DESCRIPTION

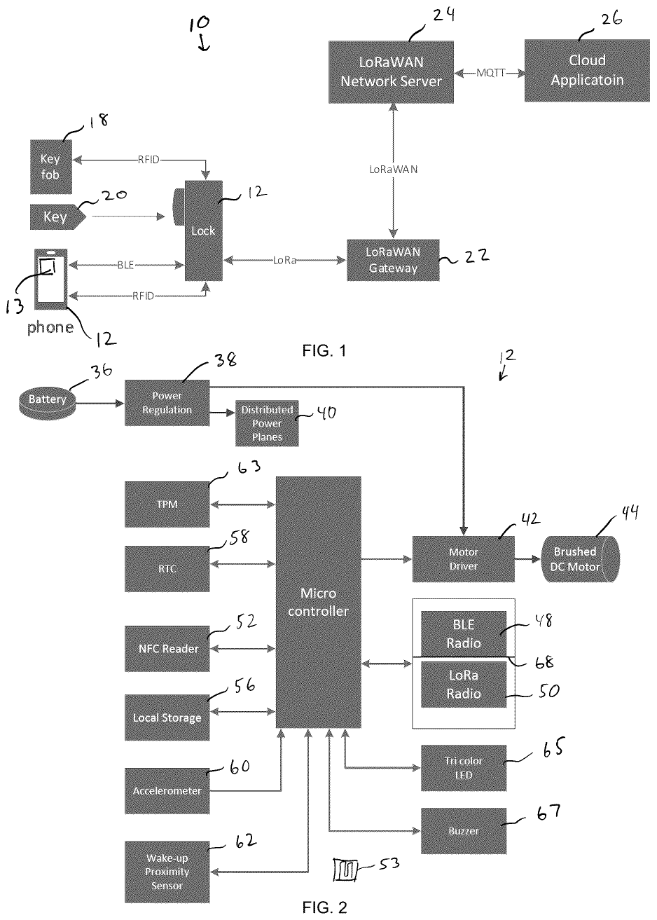

With reference to FIG. 1, a high-level design of a lock management system 10 is shown.

The system 10 includes the following components:

Lock 12: The central device in the system 10, the lock integrates both RFID and BLE modules to support diverse access methods. It maintains a local database of authorized devices and performs validation independently, ensuring uninterrupted operation even without cloud connectivity. This local database of authorized devices and codes is periodically updated when cloud connectivity with the lock is available. It also transmits operational and access data to external systems.

Mobile Device 14: The mobile device 14 functions as a versatile access tool, enabling communication over a first communication protocol (e.g., RFID/NFC) and a second communication protocol (e.g., Bluetooth Low Energy (BLE)) with the lock 12. The device 14 may also act as a gateway to facilitate communication with the cloud, providing an alternative to dedicated infrastructure. Through BLE, the device 14 transmits secure authorization credentials, such as a Time-based One-Time Password (TOTP), to the lock.

Key Fob 18 and RFID Tag: These are physical devices equipped with secure RFID chips. When presented to the lock's RFID reader, they transmit unique data, e.g., code, to validate the user's access. The lock compares this data with a locally stored list of authorized devices to grant or deny access.

Physical Key 20: This mechanical key 20 serves as a backup access mechanism. It can be used as an alternative in situations where electronic methods are unavailable.

Wireless Gateway 22: The wireless gateway serves as a bridge between the lock 12 and a network server 24. The wireless gateway 22 transmits data from the lock 12 to the network server 24 using a long-range, low-power wireless communication protocol suitable for battery-operated devices such as the lock 12 of the present disclosure. LoRaWAN is one such example of this type of protocol, enabling efficient and secure transmission of lock data over long distances.

Network Server 24: This server 24 receives data from the wireless gateway 22, processes it, and relays it to a cloud application 26 for cloud based management and reporting. It also supports updates to the lock's access control data. Network server 24 can also be part of the cloud infrastructure.

Cloud Application 26: The cloud-based management platform provides centralized control over the entire system 10. It facilitates updates to the lock's database of authorized devices, schedules, and configuration settings. Communication between the network server 24 and the cloud application 26 is managed using efficient protocols like MQTT, ensuring secure and reliable data transfer.

Operation of the system 10 is described below. When the key fob 18 is presented to the lock 12, the card which contains a secure RFID chip will be read by the lock 12. When the mobile device 14, such as a mobile phone or store computer running a custom application 16 (FIG. 4) is used, the mobile device 14 will recognize the lock 12 by reading an RFID chip inside the lock 12. The mobile device 14 may also include an RFID chip 13 that is readable by the lock. Then the device 14 will use secure Bluetooth to connect to the lock and transmit an authorization code. The lock stores a list of authorized codes and will compare these to the transmitted codes.

The lock 12 communicates with the wireless gateway 22 using any suitable wireless protocol, such as LoRa. LoRa is used to send data from the device to a LoRa gateway. From the gateway 22 the data is pushed to a LoRa Network Server 24 which can then parse the data and send it to the cloud software platform. In some configurations, the mobile device 14 can function as a wireless gateway 22 for communication with the cloud application 26. This would be an alternative to the LoRaWAN gateway.

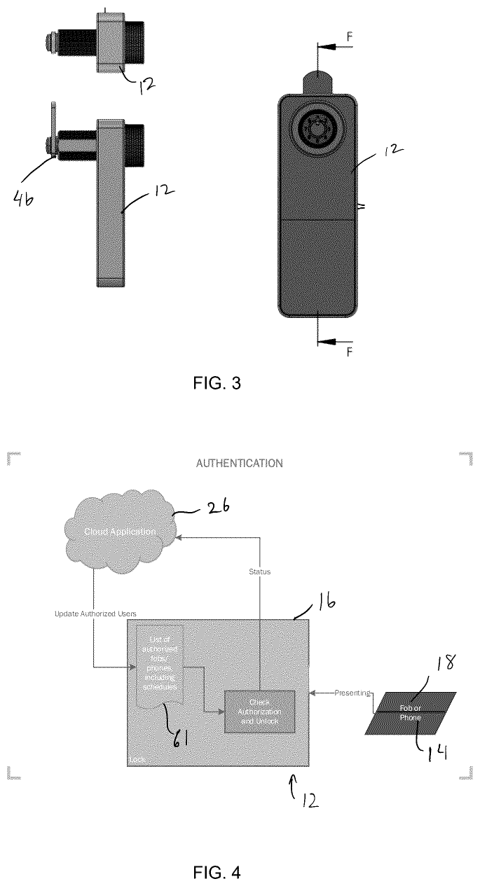

With reference to FIGS. 2 and 3, the lock 12 includes a microcontroller 34, which acts as the central processing unit, coordinating all operations within the lock 12. The lock 12 is powered by a battery 36, whose output is regulated by the Power Regulation unit 38. This ensures stable power delivery across distributed power planes 40, catering to both high-power components like the motor 44 and low-power components like the sensors and communication modules.

The microcontroller 34 is responsible for interfacing with peripheral components such as a trusted platform module (TPM) 63, the NFC Reader 52, BLE Radio 48, LoRa Radio 50, Local Storage 56, Motor Driver 42, LED 65, buzzer 67, and various sensors (e.g., accelerometer 60, wake-up sensor 62). The wake-up sensor 62 may include IR or other suitable proximity sensors. The microcontroller 34 communicates with these components through standard protocols like SPI (Serial Peripheral Interface) and UART (Universal Asynchronous Receiver-Transmitter).

The motor driver 42 and motor 44 together enable the physical locking and unlocking mechanism 46 (FIG. 3). The microcontroller sends commands to the motor driver 42 to actuate the motor 44, which physically secures or releases the lock 12. The distributed power planes 40 from the power regulation unit provide sufficient energy for motor operations.

The BLE radio 48 and LoRa radio 50 are responsible for wireless communication. The BLE Radio supports short-range communication with mobile devices 14, enabling secure data exchange and user access through features like Bluetooth-based key sharing. The LoRa Radio 50, as an example of a long-range, low-power wireless communication technology, allows the lock 12 to transmit data to external servers or gateways over large distances, enabling cloud-based management.

The NFC reader 52 interacts with RFID tags, key fobs, or mobile phones, providing an additional method for user authentication. This reader communicates with the microcontroller 34 via the SPI interface.

Local storage 56 is used to maintain an on-device access control list, ensuring that the lock can validate access locally without relying on real-time connectivity to the cloud. This control list of authorized devices and codes is periodically updated when cloud connectivity with the cloud application 26 is available. This improves resilience by allowing the lock to function during network outages.

To further enhance device security, the lock 12 includes TPM 63 (or secure element) in communication with the microcontroller 34. The TPM 63 is configured to securely generate and store cryptographic keys, certificates, and passwords that are employed during secure data transmissions (e.g., over BLE or LoRaWAN) and local authentication processes. By storing sensitive credentials—such as the lock's private key or the symmetric keys used for encryption—within the dedicated hardware of the TPM 63, the system ensures that these keys remain isolated from the main processor, protecting them against software-based attacks or physical extraction attempts.

The lock 12 further includes user interface components to provide visual and audible (or haptic) status feedback to the user. The LED 65, which may be a multi-color LED, is coupled to the microcontroller 34 and is configured to emit distinct colors or lighting patterns corresponding to different lock states (e.g., flashing green for ‘Access Granted,’ solid red for ‘Access Denied,’ or blinking blue for ‘Bluetooth Pairing Mode’). Additionally, the buzzer 67 (which may also be configured as a haptic feedback device) is connected to the microcontroller 34 to provide audio or tactile confirmation of user inputs. The microcontroller 34 may also trigger the buzzer 67 to sound an audible alarm if the accelerometer 60 detects tampering or forced entry attempts.

The real-time clock (RTC) 58 enables time-sensitive functionalities, such as access scheduling and logging, ensuring that access permissions adhere to specific time constraints.

The system 10 includes an accelerometer 60 and a wake-up sensor 62. The accelerometer 60can detect tampering or unauthorized physical movements, triggering security responses or alerts. The wake-up sensor 62 minimizes power consumption by keeping the lock 12 in low-power mode until an interaction, such as proximity detection or vibration, occurs.

Together, these components form a cohesive, power-efficient system 10 that supports a blend of advanced security features, local autonomy, and cloud connectivity. The modular design allows for scalability and customization, catering to a wide range of use cases and operational environments.

Because the lock 12 can either be opened with a mobile device 14 enabled with NFC and Bluetooth or an NFC/RFID tag the lock 12 includes both an NFC/RFID reader 52.

The lock 12 also incorporates power management. In particular, the microcontroller 34 goes into lower power mode until one or more of the following actions wake it up:
Internal timer is set for wake-ups on a regular interval;
Proximity sensor of wake-up sensor 62 is triggered;
Key fob 18 or device 14 is presented to reader;
Accelerometer or motion detection is triggered by the accelerometer 60; or
Theft identification using a motion sensor or accelerometer 60.

The lock's electronics, software, basic mechanical functionality, including the physical lock and key may support multiple fixture locking designs including cam, plunger, bolt, drawer, snap bolt, ratchet, and padlock types of locks.

FIG. 4 shows lock's local authentication system and process. The authentication process is performed locally on the lock 12, and this authentication is key-based (either fob 18 or device 14) rather than user-based. The lock 12 maintains (locally stored on the lock 12) a list 61 of the fobs 18/devices 14 which may be used to unlock this lock 12. This list 61 is periodically updated when cloud connectivity is available.

When a fob 18 or device 14 is presented to the lock 12, the lock 12 determines locally whether the fob 18 or device 14 is authorized to unlock the lock 12. This may also include verifying a schedule stored locally as to whether the fob 18 or device 14 is permitted to unlock the lock at a particular time.

Thus, the lock 12 does not need to communicate with the cloud application 26 to determine whether the fob 18 or device 14 is authorized. The benefit is that the lock 12 will properly operate if cloud application 26 is temporarily unavailable. Furthermore, the lock 12 validates fobs 18 or devices 14, rather than specific users. Novel to this design is that the association of a fob 18 or device 14 with a user is a construct available in the cloud application 26 but not required for the operation of the lock 12.

The cloud application 26 can manage and update the list of fobs 18 and devices 14 that are permitted to operate the lock 12. The cloud application 26 can also update the schedule of permitted operations. The updated authorization information is communicated to the lock 12 to be used during authentication when the fob 18 or device 14 is presented.

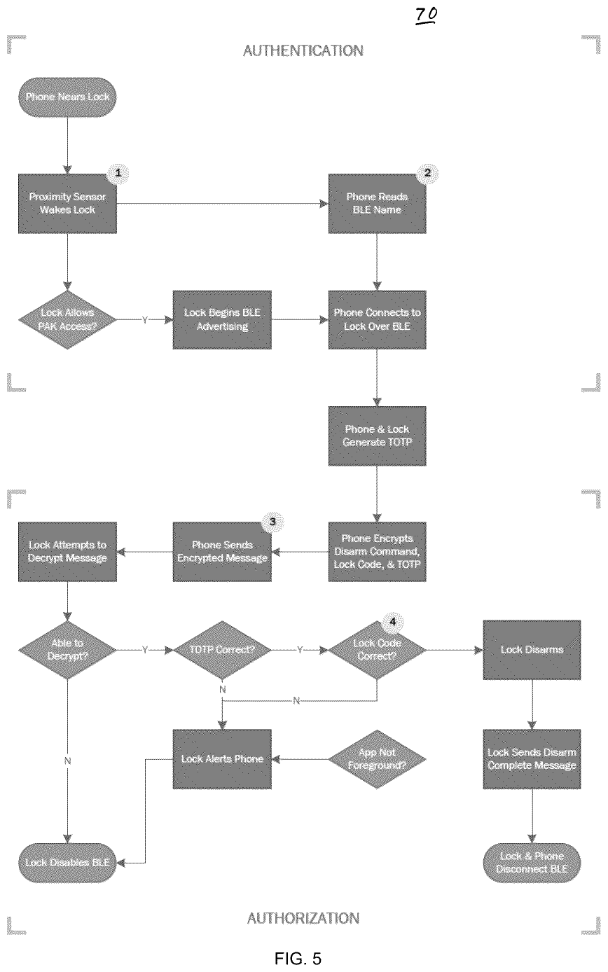

With reference to FIG. 5, shows a flow chart of a method 70 for using the device 14 as a key. The method 70 may be implemented as software instructions stored in memory and executed by a processor of the device 14, the lock 12, cloud servers, etc.

At step 1, a proximity sensor wakes the lock when the user (or the user's device 14) nears the lock 12. This is done to reduce power and preserve battery life. When the device 14 nears the lock 12, the proximity sensor of the wake-up sensor 62 embedded in the lock 12 detects the approach of a person and/or the device 14 and activates (e.g., wakes) the lock 12 from its low-power state. This ensures energy efficiency by keeping the lock 12 dormant until interaction is imminent. Once awakened, the lock 12 checks whether device-as-key access is enabled for the device 14.

At step 2, the device 14 reads a BLE name, which is stored on the tag 53 or reported by the NFC module of the lock 12 using NFC communication. Once the BLE name is read from the lock 12, a BLE scan is opened to search for the lock and then to connect to it once found. Once the BLE name is validated, the device 14 connects to the lock 12 over BLE, establishing a secure encrypted communication channel. If the device 14 is locked or the associated app is running in the background, the lock alerts the device 14 and disables BLE to prevent unauthorized access.

Thus, the mobile device 14 performs a secure transaction using a first communication protocol, e.g., NFC, to obtain the information to establish a second communication protocol, e.g., BLE, and an encrypted identifier from the lock 12, verifying the lock's authenticity. Upon successful verification, the mobile device 14 uses the decrypted identifier to establish a secure connection with the lock 12 via the second communication protocol, enabling mutual authentication and secure interaction while preventing unauthorized access.

At step 3, the device 14 generates and sends a Time-based One Time Password (TOTP) and key code over to the device 14 which uniquely identifies the user as an authorized user permitted to unlock the lock 12 and prevents replay attacks. The device 14 then transmits user authorization data and the TOTP to the lock 12. The lock cross-checks the received key code against its internally stored list of valid key codes to ensure that the request originates from an authorized device. If the key code is incorrect, access is denied.

At step 4, the lock 12 validates the TOTP as correct and validates that the user requesting access is permitted access to this lock 12. If the TOTP is valid, the lock 12 performs a final check to verify whether the user associated with the device 14 is authorized to unlock the lock. If the user fails this check, access is denied. The device 14 may output an audio, visual, and/or haptic alert to the user that access is denied. Otherwise, the lock 12 unlocks, allowing access, and sends a confirmation message to the device 14. The device 14 may output an audio, visual, and/or haptic alert to the user that the lock 12 is unlocked. Finally, the lock 12 and device 14 disconnect the BLE connection to terminate the session securely.

This method 70 ensures a layered approach to security, combining physical proximity detection, cryptographic verification, and strict authorization checks to prevent unauthorized access and safeguard the lock.

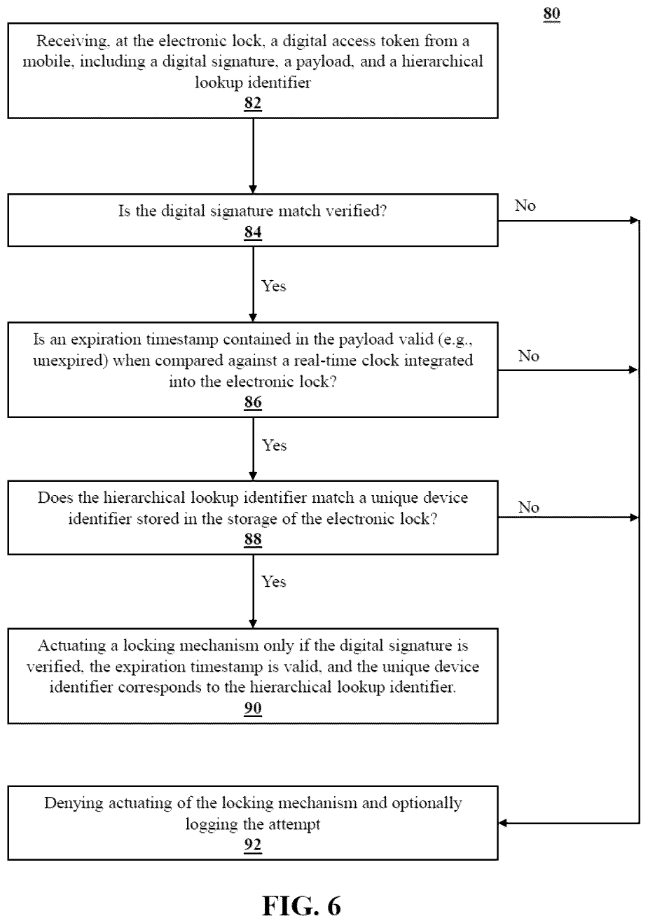

In an additional or alternative embodiment, the system executes a cryptographic token-based access control method, designated herein as method 80. FIG. 6 shows a flow chart of the method 80, which ensures authenticity and integrity without requiring real-time connectivity between the electronic lock 12 and external networks, e.g., cloud application 26.

The method begins at step 82, where the lock 12 receives a digital access token from mobile device 14. This transmission occurs via the BLE Radio Module 48 or the NFC/RFID Reader 52. The access token contains a digital signature, a header, and a payload. The payload includes a hierarchical lookup identifier (e.g., “1.2.45.”) and an expiration timestamp.

At step 84, the microcontroller 34 parses the received token and performs a signature verification. The microcontroller 34 retrieves a cryptographic public key stored in the local storage 56 and uses it to mathematically verify that the token's digital signature was generated by a trusted private key held by the cloud application 26, this local verification confirms that the token was originally generated and signed by the trusted cloud server. This process may occur entirely within electronic lock 12 without a need for an active network connection to the cloud application 26 at the time of access. If the digital signature is invalid, the method terminates, and access is denied.

Upon successful signature verification, the method proceeds to step 86, where the microcontroller 34 validates the token's lifespan. The microcontroller 34 compares the expiration timestamp found in the token payload against the current time provided by the RTC 58. If the current time is past the expiration timestamp, the method terminates, and access is denied.

If the token is active, the method proceeds to step 88 for hierarchical authorization. The microcontroller 34 extracts the lookup identifier from the token payload and compares it against the unique device identifier stored in the local storage 56. The microcontroller 34 determines if the device identifier corresponds to the hierarchy specified in the token. For example, the validation is successful if the device identifier contains a prefix matching the lookup identifier (e.g., a token for group “1.2.45.” authorizes a lock with ID “1.2.45.122”). In various embodiments, steps 84, 86, and 88 may be executed in an order different from that described above, or may be executed simultaneously. This hierarchical prefix matching enables a single digital access token to authorize access to a defined group of electronic locks (e.g., all locks within a specific department, store, or region) that share the same hierarchical prefix. Consequently, a user device need not store a unique credential for every individual lock; instead, a single ‘group’ token effectively unlocks any lock belonging to that hierarchical level.

If the hierarchy match is confirmed, the method concludes at step 90, where the microcontroller 34 commands the motor driver 42 to actuate the motor 44 and unlock the locking mechanism. The device 14 may output an audio, visual, and/or haptic alert to the user that the lock 12 is unlocked. If the hierarchy match fails, at step 92 the microcontroller 34 prevents actuation of the locking mechanism, denies access, and may log the attempt in local storage 56. The device 14 may output an audio, visual, and/or haptic alert to the user that access is denied.

Further aspects and embodiments of the present disclosure are set out in the below numbered clauses:
1. A method for securing and controlling access to an electronic lock, comprising: (a) detecting a presence of a mobile device near the electronic lock using a proximity sensor to wake the lock from a low-power state; (b) performing an initial authentication by reading, via the mobile device, a near-field communication (NFC) signature and an encrypted Bluetooth Low Energy (BLE) name from a passive NFC tag integrated into the lock or from an NFC module; (c) verifying, by the mobile device, the NFC signature and decrypting the BLE name; (d) upon successful verification, establishing a secure BLE connection between the mobile device and the lock; (e) generating a time-based one-time password (TOTP) by the mobile device and transmitting the TOTP along with user authorization data to the lock over the BLE connection; (f) validating, by the lock, the TOTP and user authorization data against an access control list stored locally on the lock; and (g) upon successful validation, unlocking the lock and sending a confirmation message to the mobile device.
2. The method of clause 1, further comprising: disabling BLE on the lock and notifying the user via the mobile device if the NFC signature or BLE name verification fails.
3. The method of any preceding clause, wherein the proximity sensor comprises at least one of a motion detector configured to activate the lock upon detecting proximity of the mobile device.
4. The method of any preceding clause, wherein the NFC signature and BLE name are encrypted using a cryptographic key stored in the lock and verified by the mobile device using a corresponding decryption key.
5. The method of any preceding clause, wherein the TOTP is generated based on a cryptographic algorithm shared between the mobile device and the lock.
6. The method of any preceding clause, wherein user authorization data includes at least one of a device identifier, a session identifier, or user credentials for validating access.
7. The method of any preceding clause, wherein the access control list stored locally on the lock is periodically updated from a cloud-based access control system via a wireless communication gateway.
8. The method of any preceding clause, wherein the lock operates independently of cloud connectivity by performing authentication and authorization locally.
9. The method of any preceding clause, further comprising disconnecting the BLE connection between the mobile device and the lock upon successful or failed completion of the validation.
10. The method of any preceding clause, further comprising enabling power management features of the lock, wherein the lock remains in a low-power state until triggered by the proximity sensor.
11. The method of any preceding clause, further comprising: (a) generating a security alert in response to multiple failed NFC or BLE authentication attempts occurring within a predetermined time frame; and (b) transmitting the alert to a remote server or a user device.
12. The method of any preceding clause, wherein the lock validates authorization data based on a predefined schedule stored locally, allowing or denying access based on time constraints.
13. A method for authorizing access to an electronic lock using a cryptographic token, comprising: receiving, at the electronic lock, a digital access token from a mobile device via a wireless communication link, the digital access token comprising a digital signature, a payload, and a hierarchical lookup identifier; verifying, by a microcontroller of the electronic lock, the digital signature using a cryptographic public key stored locally in a storage of the electronic lock; checking, by the microcontroller, an expiration timestamp contained in the payload against a real-time clock integrated into the electronic lock; comparing the hierarchical lookup identifier against a unique device identifier stored in the storage of the electronic lock; and actuating a locking mechanism only if the digital signature is verified, the expiration timestamp is valid, and the unique device identifier corresponds to the hierarchical lookup identifier indicates membership in a group defined by the hierarchical group identifier.
14. The method of clause 13, wherein the membership in the group is determined by identifying that the unique device identifier contains a prefix matching the hierarchical group identifier.
15. The method of any one of clauses 13 to 14, wherein the digital access token is a signed JSON Web Token (JWT) issued by a remote server using a private key corresponding to the cryptographic public key.
16. The method of any one of clauses 13 to 15, wherein the wireless communication link is a Bluetooth Low Energy (BLE) connection, and wherein the method is performed by the electronic lock while disconnected from external networks.
17. An electronic lock system capable of multi-modal authentication, comprising: (a) a lock assembly comprising a locking mechanism and a motor; (b) a wireless communication module comprising a Bluetooth Low Energy (BLE) radio and a Near Field Communication (NFC) component; (c) a proximity sensor configured to detect a presence of a user; (d) a local storage memory storing access credentials and a unique device identifier; (e) a real-time clock; and (f) a microcontroller coupled to the motor, wireless communication module, proximity sensor, and local storage memory, wherein the microcontroller is configured to transition from a low-power state to an active state upon triggering of the proximity sensor.
18. The electronic lock system of clause 17, wherein the microcontroller is configured to: establish a secure connection with a mobile device via the BLE radio; receive a Time-Based One-Time Password (TOTP) and user authorization data from the mobile device; compare the received TOTP against a valid TOTP generated locally synchronized with the real-time clock; validate the user authorization data against an access control list stored in the local storage memory; and actuate the motor to unlock the locking mechanism only upon successful validation of both the TOTP and the user authorization data.
19. The electronic lock system of clause 18, wherein the NFC component comprises a passive NFC tag storing an encrypted BLE name and a digital signature, and wherein the microcontroller is configured to enable the BLE radio for advertising only after the passive NFC tag has been interrogated by the mobile device.
20. The electronic lock system of any one of clauses 17 to 19, wherein the microcontroller is configured to: receive a digital access token comprising a digital signature and a hierarchical lookup identifier; verify the digital signature using a cryptographic public key stored in the local storage memory; compare the hierarchical lookup identifier against the unique device identifier stored in the local storage memory; and actuate the motor if the digital signature is valid and the unique device identifier corresponds to the hierarchical lookup identifier comprises the hierarchical group identifier, thereby confirming the electronic lock belongs to an authorized group defined by the token.
21. The electronic lock system of clause 17, wherein the NFC component is configured to read a unique identifier from a physical key fob, and wherein the microcontroller is configured to validate the unique identifier against the access credentials stored in the local storage memory to actuate the motor.

Alternate embodiments may be devised without departing from the spirit or the scope of the present technology. Additionally, well-known elements of embodiments of the systems, apparatuses, and methods have not been described in detail or have been omitted so as not to obscure the relevant details of the systems, apparatuses, and methods.

The terminology used herein is for the purpose of describing particular embodiments only and is not intended to be limiting. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. The terms “including” and/or “having,” as used herein, are defined as comprising (i.e., open language). The terms “a” or “an”, as used herein, are defined as one or more than one. The term “plurality,” as used herein, is defined as two or more than two. The term “another,” as used herein, is defined as at least a second or more. The description may use the terms “embodiment” or “embodiments,” which may each refer to one or more of the same or different embodiments.

When the terms “coupled” and “connected,” along with their derivatives, are used, these terms are not intended as synonyms for each other. For example, “connected” may be used to indicate that two or more elements are in direct physical or electrical contact with each other. “Coupled” may mean that two or more elements are in direct physical or electrical contact (e.g., directly coupled) or that two or more elements are not in direct contact with each other but yet still cooperate or interact with each other (e.g., indirectly coupled).

For the purposes of the description, a phrase in the form “A/B” or in the form “A and/or B” or in the form “at least one of A and B” means (A), (B), or (A and B), where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables, for example, a phrase in the form “at least one of A, B, and C” means (A), (B), (C), (A and B), (A and C), (B and C), or (A, B and C).

Relational terms such as first and second, top and bottom, and the like may be used solely to distinguish one entity or action from another entity or action without necessarily requiring or implying any actual such relationship or order between such entities or actions. The description may use perspective-based descriptions such as up/down, back/front, top/bottom, and proximal/distal. Such descriptions are merely used to facilitate the discussion and are not intended to restrict the application of disclosed embodiments. Various operations may be described as multiple discrete operations in turn, in a manner that may be helpful in understanding embodiments; however, the order of description should not be construed to imply that these operations are order dependent.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one skill in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

Various embodiments of the systems, apparatuses, and methods have been described, and in many of the different embodiments many features are similar. To avoid redundancy, repetitive description of these similar features may not be made in some circumstances. It shall be understood, however, that description of a first-appearing feature applies to the later described similar feature and each respective description, therefore, is to be incorporated therein without such repetition.

What is claimed is:

1. A method for securing and controlling access to an electronic lock, comprising:
(a) detecting a presence of a mobile device near the electronic lock using a proximity sensor to wake the lock from a low-power state;
(b) performing an initial authentication by reading, via the mobile device, a near-field communication (NFC) signature and an encrypted Bluetooth Low Energy (BLE) name from a passive NFC tag integrated into the lock or from an NFC module;
(c) verifying, by the mobile device, the NFC signature and decrypting the BLE name;
(d) upon successful verification, establishing a secure BLE connection between the mobile device and the lock;
(e) generating a time-based one-time password (TOTP) by the mobile device and transmitting the TOTP along with user authorization data to the lock over the BLE connection;
(f) validating, by the lock, the TOTP and user authorization data against an access control list stored locally on the lock; and
(g) upon successful validation, unlocking the lock and sending a confirmation message to the mobile device.

2. The method of claim 1, further comprising:
disabling BLE on the lock and notifying the user via the mobile device if the NFC signature or BLE name verification fails.

3. The method of claim 1, wherein the proximity sensor comprises at least one of a motion detector configured to activate the lock upon detecting proximity of the mobile device.

4. The method of claim 1, wherein the NFC signature and BLE name are encrypted using a cryptographic key stored in the lock and verified by the mobile device using a corresponding decryption key.

5. The method of claim 1, wherein the TOTP is generated based on a cryptographic algorithm shared between the mobile device and the lock.

6. The method of claim 1, wherein user authorization data includes at least one of a device identifier, a session identifier, or user credentials for validating access.

7. The method of claim 1, wherein the access control list stored locally on the lock is periodically updated from a cloud-based access control system via a wireless communication gateway.

8. The method of claim 1, wherein the lock operates independently of cloud connectivity by performing authentication and authorization locally.

9. The method of claim 1, further comprising disconnecting the BLE connection between the mobile device and the lock upon successful or failed completion of the validation.

10. The method of claim 1, further comprising enabling power management features of the lock, wherein the lock remains in a low-power state until triggered by the proximity sensor.

11. The method of claim 1, further comprising:
(a) generating a security alert in response to multiple failed NFC or BLE authentication attempts occurring within a predetermined time frame; and
(b) transmitting the alert to a remote server or a user device.

12. The method of claim 1, wherein the lock validates authorization data based on a predefined schedule stored locally, allowing or denying access based on time constraints.

13. A method for authorizing access to an electronic lock using a cryptographic token, comprising:
receiving, at the electronic lock, a digital access token from a mobile device via a wireless communication link, the digital access token comprising a digital signature, a payload, and a hierarchical lookup identifier;
verifying, by a microcontroller of the electronic lock, the digital signature using a cryptographic public key stored locally in a storage of the electronic lock;
checking, by the microcontroller, an expiration timestamp contained in the payload against a real-time clock integrated into the electronic lock;
comparing the hierarchical lookup identifier against a unique device identifier stored in the storage of the electronic lock; and
actuating a locking mechanism only if the digital signature is verified, the expiration timestamp is valid, and the unique device identifier corresponds to the hierarchical lookup identifier indicates membership in a group defined by the hierarchical group identifier.

14. The method of claim 13, wherein the membership in the group is determined by identifying that the unique device identifier contains a prefix matching the hierarchical group identifier.

15. The method of claim 13, wherein the digital access token is a signed JSON Web Token (JWT) issued by a remote server using a private key corresponding to the cryptographic public key.

16. The method of claim 13, wherein the wireless communication link is a Bluetooth Low Energy (BLE) connection, and wherein the method is performed by the electronic lock while disconnected from external networks.

17. An electronic lock system capable of multi-modal authentication, comprising:
(a) a lock assembly comprising a locking mechanism and a motor;
(b) a wireless communication module comprising a Bluetooth Low Energy (BLE) radio and a Near Field Communication (NFC) component;
(c) a proximity sensor configured to detect a presence of a user;
(d) a local storage memory storing access credentials and a unique device identifier;
(e) a real-time clock; and
(f) a microcontroller coupled to the motor, wireless communication module, proximity sensor, and local storage memory, wherein the microcontroller is configured to transition from a low-power state to an active state upon triggering of the proximity sensor.

18. The electronic lock system of claim 17, wherein the microcontroller is configured to:
establish a secure connection with a mobile device via the BLE radio;
receive a Time-Based One-Time Password (TOTP) and user authorization data from the mobile device;
compare the received TOTP against a valid TOTP generated locally synchronized with the real-time clock;
validate the user authorization data against an access control list stored in the local storage memory; and
actuate the motor to unlock the locking mechanism only upon successful validation of both the TOTP and the user authorization data.

19. The electronic lock system of claim 18, wherein the NFC component comprises a passive NFC tag storing an encrypted BLE name and a digital signature, and wherein the microcontroller is configured to enable the BLE radio for advertising only after the passive NFC tag has been interrogated by the mobile device.

20. The electronic lock system of claim 17, wherein the microcontroller is configured to:
receive a digital access token comprising a digital signature and a hierarchical lookup identifier; verify the digital signature using a cryptographic public key stored in the local storage memory; compare the hierarchical lookup identifier against the unique device identifier stored in the local storage memory; and
actuate the motor if the digital signature is valid and the unique device identifier corresponds to the hierarchical lookup identifier comprises the hierarchical group identifier, thereby confirming the electronic lock belongs to an authorized group defined by the token.

21. The electronic lock system of claim 17, wherein the NFC component is configured to read a unique identifier from a physical key fob, and wherein the microcontroller is configured to validate the unique identifier against the access credentials stored in the local storage memory to actuate the motor.
